(19) United States
(12) Patent Application Publication
(10) Pub. No.: US 2026/0024515 A1
(43) Pub. Date: Jan. 22, 2026

(54) ELECTRONIC INSTRUMENT, MUSICAL SOUND OUTPUT METHOD, AND NON-TRANSITORY COMPUTER READABLE MEDIUM

(71) Applicant: Roland Corporation, Shizuoka (JP)

(72) Inventors: Takashi Nishimura, Hamamatsu (JP); Keigo TSUTAKI, Hamamatsu (JP)

(73) Assignee: Roland Corporation, Shizuoka (JP)

(21) Appl. No.: 19/096,742

(22) Filed: Apr. 1, 2025

(30) Foreign Application Priority Data
Jul. 22, 2024 (JP) 2024-117088

(51) Int. Cl. G10H 1/053; G10H 1/18

(52) U.S. Cl. CPC G10H 1/053; G10H 1/182; G10H 2210/181; G10H 2210/281; G10H 2220/221; G10H 2220/275

(57) ABSTRACT

An electronic instrument including a keyboard having multiple keys. The electronic instrument includes: a normal musical sound generation device, configured to generate a normal musical sound in a case where a position of the key reaches a sound generation start position after the key is pressed; and a key release processing device, configured to perform a key release AT process, which is a predetermined musical sound control process at a time of key release of the key, in a case where the position of the key reaches an AT detection position as a position deeper than the sound generation start position through further pressing the key after the position of the key reaches the sound generation start position.

### CROSS-REFERENCE TO RELATED APPLICATION

This application claims the priority benefit of Japan application serial no. 2024-117088, filed on Jul. 22, 2024. The entirety of the above-mentioned patent application is hereby incorporated by reference herein and made a part of this specification.

### BACKGROUND

### Technical Field

The disclosure relates to an electronic instrument, a musical sound output method, and a musical sound output program.

### Description of Related Art

There is a demand for performing a predetermined musical sound control process, such as generating a musical sound with a different timbre immediately after the end of sound generation of a musical sound, like a fall sound in brass instruments. For example, in Patent Document 1, a musical sound control process for generating a musical sound of a different timbre immediately after the end of sound generation of a musical sound is made possible by selecting, by the user, a button of a group of tone buttons 102 on a panel of an electronic keyboard instrument 100 immediately after the end of sound generation of the musical sound.

[Patent Document 1] Japanese Laid-open No. 2022-6706

However, in the case of performing a musical sound control process for generating another musical sound immediately after the end of sound generation of a musical sound, there is an issue that the operability deteriorates because the user must operate a button from the group of tone buttons 102 at the timing of the end of sound generation of the initial musical sound.

The invention provides an electronic instrument, a musical sound output method, and a musical sound output program that can easily perform a key release AT (Aftertouch) process after the generation of a normal musical sound.

### SUMMARY

An electronic instrument according to the invention includes a keyboard having multiple keys. In addition, the electronic instrument includes: a normal musical sound generation device, configured to generate a normal musical sound in a case where a position of the key reaches a sound generation start position after the key is pressed; and a key release processing device, configured to perform a key release aftertouch process, which is a predetermined musical sound control process at a time of key release of the key, in a case where the position of the key reaches an aftertouch detection position as a position deeper than the sound generation start position through further pressing the key after the position of the key reaches the sound generation start position.

A musical sound output method executed by an electronic instrument including a keyboard having multiple keys, includes: a normal musical sound generation step of generating a normal musical sound in a case where a position of the key reaches a sound generation start position after the key is pressed; and a key release processing step of performing a key release aftertouch process, which is a predetermined musical sound control process at a time of key release of the key, in a case where the position of the key reaches an aftertouch detection position as a position deeper than the sound generation start position through further pressing the key after the position of the key reaches the sound generation start position.

A non-transitory computer readable medium, storing a musical sound output program. The musical sound output program causes a computer including a keyboard having multiple keys to execute a musical sound output process. The musical sound output program causes the computer to execute: a normal musical sound generation step of generating a normal musical sound in a case where a position of the key reaches a sound generation start position after the key is pressed; and a key release processing step of performing a key release AT process, which is a predetermined musical sound control process when the key is released, in a case where the position of the key reaches an AT detection position as a position deeper than the sound generation start position through further pressing the key after the position of the key reaches the sound generation start position.

### BRIEF DESCRIPTION OF THE DRAWINGS

FIG. 1 is a view illustrating the external appearance of a synthesizer.

FIG. 2 is a cross-sectional view of a keyboard.

FIG. 3A is a partially enlarged cross-sectional view of the keyboard showing a state in the middle of key-pressing in which a white key is pressed from the state shown in FIG. 1, and FIG. 3B is a partially enlarged cross-sectional view of the keyboard showing a state where the white key that is further pressed from the state of FIG. 3A contacts a key press stopper.

FIG. 4A is a partially enlarged cross-sectional view of the keyboard showing a state where the key is further pressed from the state shown in FIG. 3B, and FIG. 4B is a graph showing a relationship between a stroke amount of the key and a sensor output value.

FIG. 5A is a graph illustrating the transition of the position of a key in a case where a normal musical sound is generated, and FIG. 5B is a graph illustrating the transition of the position of the key in the case where a key release AT process is performed.

FIG. 6 is a functional block diagram of the synthesizer.

FIG. 7 is a block diagram showing an electrical configuration of the synthesizer.

FIG. 8A is a flowchart of a main process, and FIG. 8B is a flowchart of a normal musical sound start process.

FIG. 9A is a flowchart of an AT detection process, and FIG. 9B is a flowchart of a silencing process.

FIG. 10 is a flowchart of a key release process.

### DESCRIPTION OF THE EMBODIMENTS

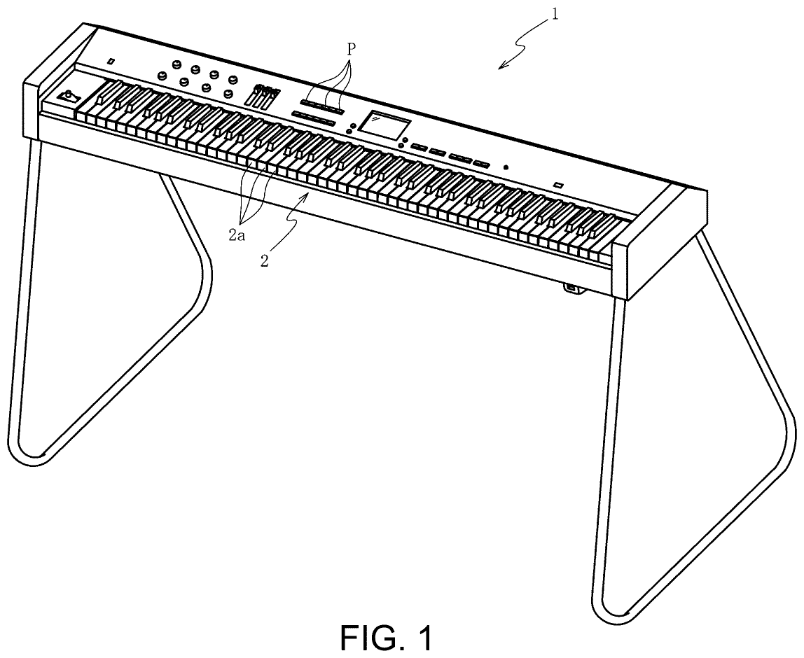

The following describes exemplary embodiments with reference to the accompanying drawings. Referring to FIG. 1, an overview of a synthesizer 1 of the embodiment is described. FIG. 1 is a view showing the external appearance of the synthesizer 1. The synthesizer 1 is an electronic instrument that outputs (emits sound) by mixing a musical sound based on the performance operation of the user H and a predetermined accompaniment sound. The synthesizer 1 can apply an acoustic effect (effect) such as reverb, chorus, and delay by performing a computational process on waveform data that mix the musical sounds from the user H's performance and the accompaniment sounds.

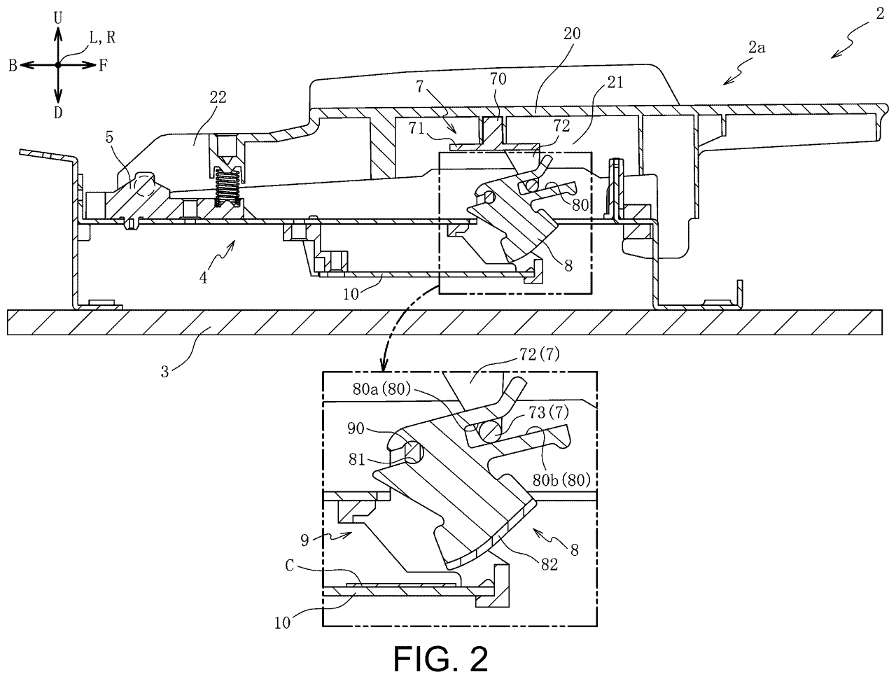

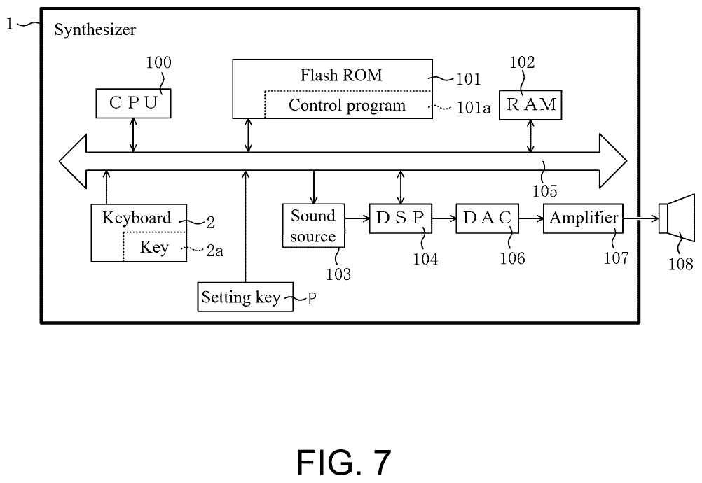

The synthesizer 1 is mainly provided with a keyboard 2 and a setting button P for inputting various settings from the user H. The keyboard 2 is provided with multiple keys 2a and serves as an input device for obtaining performance information according to the performance of the user H. Key press information in accordance with key press/release operations (i.e., performance operations) of the user H on the keys 2a is output to a CPU 100 (see FIG. 7). Here, the configuration of the keyboard 2 is described with reference to FIG. 2 to FIG. 4B.

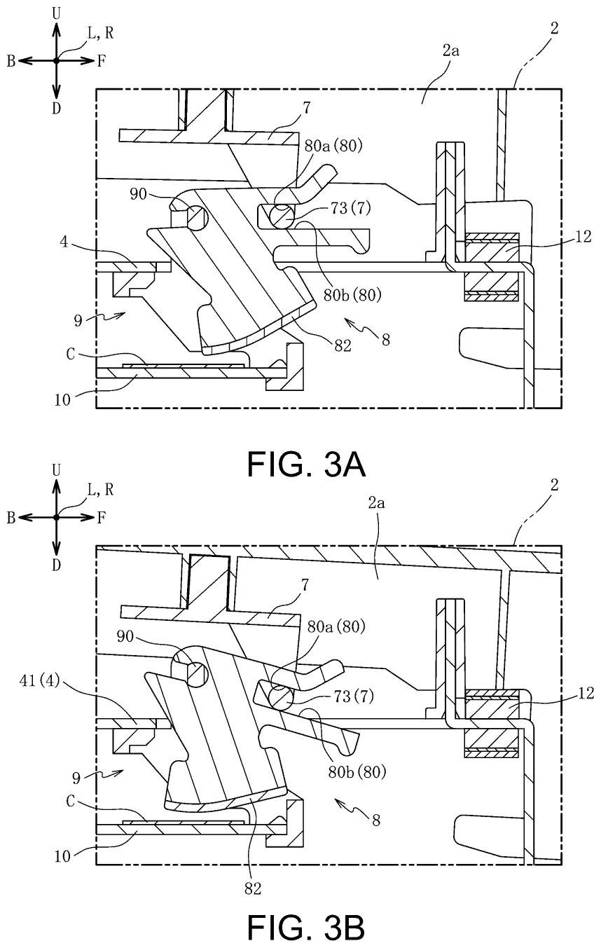

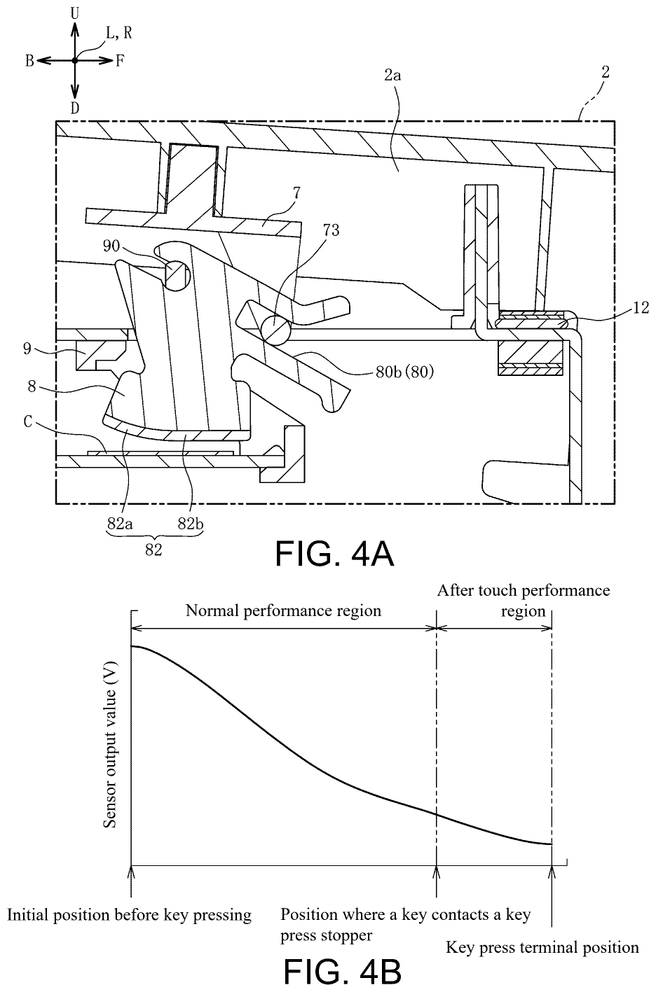

FIG. 2 is a cross-sectional view of the keyboard 2. Arrow directions U-D, F-B, and L-R in FIG. 2 indicate the upper-lower direction, the front-rear direction, and the left-right direction (the direction in which the keys 2a are arranged, hereinafter referred to as the “scale direction”) of the keyboard 2, respectively, and the same applies to FIGS. 3A, 3B, FIGS. 4A, 4B and subsequent figures. FIG. 2 is a cross-sectional view of the keyboard 2 cut along a plane orthogonal to the scale direction. The keyboard 2 includes a base plate 3 for supporting the keys 2a. The base plate 3 is formed as a flat plate extending in the scale direction by using synthetic resin or a steel plate, and a chassis 4 is supported on the upper surface of the base plate 3.

The key 2a is provided with an upper plate 20 and a pair of side plates 21. An upper surface (the surface on the side of the arrow U) of the upper plate is configured as a key press surface to be pressed down by the user H. The pair of side plates 21 extend downward from both ends of the upper plate 20 in the left-right (arrow L-R direction) direction. The plate-shaped upper plate 20 and side plates 21 are integrally formed by using a resin material, and the key 2a is formed in a box shape having an opening at the bottom. A plate-shaped protrusion part 22 protrudes toward the rear side from the rear end (the end on the side of the arrow B) of the key 2a. The protrusion part 22 is supported by a key shaft member 5.

Additionally, a linkage member 7 is attached to the concave part surrounded by the upper plate 20 and the side plates 21. The linkage member 7 is a member for interlocking the displacement member 8 with the swinging of the key 2a at the time of key pressing and key release. The linkage member 7 is provided with a columnar inserted part 70, an overhang part 71, and a plate-shaped protrusion part 72. The inserted part 70 extends in the upper-lower direction. The overhang part 71 protrudes forward and rearward from the lower end of the inserted part 70. The plate-shaped protrusion part 72 protrudes downward from the front end portion of the overhang part 71.

The inserted part 70 is formed in a shape corresponding to the concave part, and the linkage member 7 is attached to the key 2a by adhering the key 2a to the inserted part 70 inserted into the concave part. A cylindrically columnar guide pin 73 protruding in the scale direction (the side of the arrow R) is integrally formed at the lower end of the protrusion part 72, and the guide pin 73 is hooked to a groove 80 formed in the displacement member 8.

The groove 80 penetrates both side surfaces of the displacement member 8 facing the scale direction and extends in a direction orthogonal to the scale direction (inclined upward toward the front at the initial position before key-pressing of the key 2a as shown in FIG. 2). At the initial position before the key 2a is pressed, the groove 80 extends to intersect with the displacement trajectory of the guide pin 73. The displacement member 8 interlocks with the rotation of the key 2a through sliding of the guide pin 73 along the groove 80. Hereinafter, among the groove 80 of the displacement member 8, the upper and lower surfaces along which the guide pin 73 slides during key press (key release) of the key 2a are referred to as an “upper slide surface 80a” and a “lower slide surface 80b”, respectively.

The displacement member 8 is formed with a shaft hole 81 that penetrates the displacement member 8 in the scale direction, and a rotation shaft 90 formed on the holder 9 is inserted into the shaft hole 81, so that the displacement member 8 is rotatably supported by the holder 9. Hereinafter, in the state where the displacement member 8 is supported by the rotation shaft 90, the outer surface of the displacement member 8 facing the direction orthogonal to the axial direction (scale direction) of the rotation shaft 90 is referred to as the “outer circumferential surface”.

A detected part 82 is formed on the outer circumferential surface of the displacement member 8. The detected part 82 is adhered to a metal plate of a non-magnetic metal such as copper. A substrate 10 is provided at a position facing the detected part 82 (below the displacement member 8), and a coil C that generates a magnetic field is formed on the substrate 10. The key press information of the key 2a is detected by the displacement of the detected part 82 of the displacement member 8 toward the region facing the coil C (hereinafter referred to as a “detection region”).

Next, referring to FIGS. 3A and 3B, the operation of the displacement member 8 associated with the key press (key release) of the key 2a will be described. FIG. 3A is a partially enlarged cross-sectional view of the keyboard 2 showing a state in the middle of key-pressing in which the key 2a is pressed from the state shown in FIG. 2, and FIG. 3B is a partially enlarged cross-sectional view of the keyboard 2 showing a state where the white key that is further pressed from the state of FIG. 3A contacts a key press stopper 12.

As shown in FIGS. 3A and 3B, when the guide pin 73 rotates downward (clockwise in FIGS. 3A and 3B) during key-pressing of the key 2a, the lower slide surface 80b is pressed by the guide pin 73. Accordingly, the displacement member 8 rotates around the rotation shaft 90 of the holder 9 (clockwise in FIGS. 3A and 3B). With the rotation, the detected part 82 of the displacement member 8 is relatively displaced with respect to the substrate 10 supported by the holder 9. In other words, as the stroke amount of the key 2a increases from the state before key press, the penetration amount of the detected part 82 into the detection region increases. The penetration amount of the detected part 82 refers to the size of the area where the detected part 82 and the coil C face each other in the thickness direction (upper-lower direction) of the substrate 10.

On the other hand, in the case where the key 2a is released after being pressed, the guide pin 73 rotates (counterclockwise in FIGS. 3A and 3B) to return to the initial position. Due to the rotation of the guide pin 73, the upper slide surface 80a of the groove 80 is pressed up by the guide pin 73, and, as a result, the displacement member 8 rotates around the rotation shaft 90 (counterclockwise in FIGS. 3A and 3B). At this time, the penetration amount of the detected part 82 into the detection region decreases.

Since the detected part 82 is formed by using a non-magnetic metal, in a state where a current flows through the coil C to generate a magnetic field, the inductance of the coil C decreases as the penetration amount of the detected part 82 into the detection region increases, and the inductance of the coil C increases as the penetration amount of the detected part 82 into the detection region decreases. A sensor output value (V) changes based on the increase and decrease in the inductance of the coil C (see FIG. 4B). The key press information is detected based on the increase and decrease in the sensor output value.

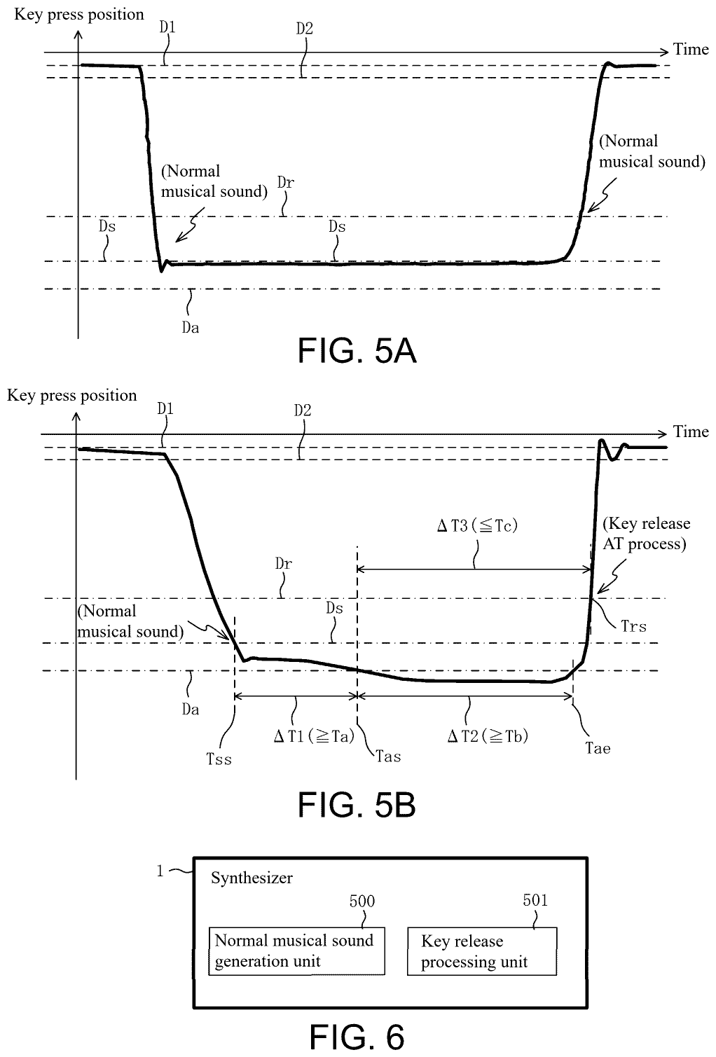

Also, as shown in FIG. 3B, the swinging when the key 2a is pressed is regulated by the key press stopper 12. The key press stopper 12 is a cushioning material adhered to the upper surface of the rear end side of the chassis 4, and the region until the lower surface of the key 2a contacts the key press stopper 12 during key press is a normal performance region. On the other hand, in the case where the key is pressed beyond the end position of the normal performance region (the state in FIG. 3B where the key 2a is in contact with the key press stopper 12), aftertouch performance is performed. At the time when the aftertouch performance is performed, a predetermined musical sound control process, namely a key release AT process, is performed at the time of key release of the key 2a. The details of the key release AT process will be described later in FIGS. 5A and 5B.

In the embodiment, in addition to the key press information during normal performance, the key press information during aftertouch performance is also detected based on a change in the magnetic field of the coil C (increase and decrease in the sensor output value). The detection method for such performance will be described with reference to FIGS. 4A and 4B.

FIG. 4A is a partially enlarged cross-sectional view of the keyboard showing a state where the key 2A is further pressed from the state shown in FIG. 3B. FIG. 4Bb is a schematic graph showing a relationship between the stroke amount of the key 2a and the sensor output value, where the vertical axis indicates the magnitude of the sensor output value (V) and the horizontal axis indicates the stroke amount of the key 2a.

As shown in FIG. 4A, when the key 2a is further pressed from the end position of normal performance (the state in FIG. 3B), the key press stopper 12 is compressed by the key 2a, while the lower slide surface 80b of the groove 80 is pressed downward by the guide pin 73 of the linkage member 7. As a result, the penetration amount of the detected part 82 into the detection region further increases.

As shown in FIG. 4B, as the penetration amount of the detected part 82 into the detection region facing the coil C increases, the sensor output value decreases. In other words, when the key 2a is pressed, the sensor output value gradually decreases as the press amount of the key 2a increases, while the sensor output value gradually increases at the time of key release of the key 2a.

To accurately detect the key press information based on the sensor output value, it is preferable that the difference between the sensor output value before key press and the sensor output value at the end position of key press (hereinafter referred to as “dynamic range”) is large. In particular, in the present embodiment, since the configuration detects the aftertouch performance from the change in the sensor output value as shown in FIG. 4B in addition to the normal performance, it is necessary to significantly decrease the sensor output value when the key 2a in contact with the key press stopper 12 is further pressed, in order to accurately detect the aftertouch.

Therefore, in the embodiment, in the detected part 82, a portion positioned on the front side (the side of the arrow B) in the rotation direction of the displacement member 8 is formed as a curved surface part 82a, and a portion continuous to the rear side of the curved surface part 82a in the same rotation direction is formed as a flat surface part 82b. The curved surface part 82a is formed in an arc shape (a curved shape convex in a direction away from the rotation shaft 90) centered on the rotation shaft 90, and the flat surface part 82b is formed in a flat shape extending in a tangential direction of the rear end (the end on the side of the arrow F) of the curved surface part 82a.

In other words, since the curvature of the flat surface part 82b is smaller than the curved surface part 82a, it is possible to bring the distance between the coil C and the detected part 82 (flat surface part 82b) closer in the aftertouch performance region than the case where the detected part 82 is a single arc shape centered on the rotation shaft 90. This allows for a significant decrease in the sensor output value in the aftertouch performance region without enlarging the displacement member 8 (coil C). In other words, it is possible to accurately detect the aftertouch while miniaturizing the displacement member 8.

In the embodiment, a predetermined state in the aftertouch is detected by using the keyboard 2 that can accurately detect aftertouch as described above, and in the case of corresponding to the predetermined state, the key release AT process is performed at the time of key release of the key 2a. Referring to FIGS. 5A and 5B, the normal musical sound and key release AT processes are described.

FIG. 5A is a graph showing the transition of the position of the key 2a (referring to the position of the key 2a in the upper-lower direction when pressing the key 2a; the same applies hereinafter) in the case of generating a normal musical sound, and FIG. 5B is a graph showing the transition of the position of the key 2a in the case of performing the key release AT process. In FIG. 5A and 5B, the vertical axis represents the position of the key 2a (key press position), and the horizontal axis represents time. In the embodiment, the position of the key 2a is assumed to become smaller (lower) as the key 2a is pressed.

The key release AT process in the embodiment is a musical sound control process that switches the normal musical sound that is being generated to a special musical sound at the time of key release of the key 2a. Here, the normal musical sound is a musical sound that is set by a standard for each key 2a, and in the embodiment, a musical sound with a timbre of “brass” is set. Comparatively, the special musical sound is a musical sound different from the normal musical sound, and in the present embodiment, a musical sound with the timbre of “fall sound” is set. It should be noted that the setting is not limited to “brass” being the normal musical sound and “fall sound” being the special musical sound, and other timbres may be set for the normal musical sound and the special musical sound.

In the present embodiment, in the key release AT process, the normal musical sound and the special musical sound are made different by setting different timbres for the normal musical sound and the special musical sound. However, the invention is not thereto. For example, the timbres of the normal musical sound and the special musical sound may be set to be the same, and the normal musical sound and the special musical sound may be made different by making the special musical sound a musical sound with a lower pitch (for example, a pitch that is only one degree lower) than the normal musical sound. At this time, the pitch of the special musical sound may be changed according to the position of the key 2a when aftertouch is applied. For instance, the pitch of the special musical sound may be lowered as the lower limit position of the key 2a when aftertouch is applied becomes smaller, and the pitch of the special musical sound may be raised as the lower limit position of the key 2a becomes greater when aftertouch is applied.

Additionally, the normal musical sound and the special musical sound may be made different by applying different acoustic effects to the normal musical sound and the special musical sound, respectively (for example, setting a delay to the normal musical sound and reverb to the special musical sound). Alternatively, the normal musical sound and the special musical sound may be made different by setting different timbre parameters, which are parameters of setting items representing aspects of timbres such as attack, decay, sustain or release, and cutoff frequency, applied to the normal musical sound and the special musical sound. For example, the release of the special musical sound may be made faster than that of the normal musical sound, or the cutoff frequency of the special musical sound may be set lower than that of the normal musical sound.

In the embodiment, according to the position of the key 2a, a key release position D1, a sound silencing position D2, a key release start position Dr, a sound generation start position Ds, and an aftertouch detection position Da (hereinafter abbreviated as “AT detection position Da”) are provided. The key release position D1 is a position to which the key 2a moving upward returns in the case where the user H presses the key 2a and then releases the key 2a. The key release position D1 is also a position before the user H touches the key 2a.

The sound silencing position D2 is a position provided lower than the key release position D1. In the case where the key 2a is released and the position of the key 2a becomes equal to or higher than the sound silencing position D2, the normal musical sound or the special musical sound assigned to the key 2a that is generating sound starts to be silenced.

The key release start position Dr is a position provided lower than the sound silencing position D2. When the key 2a is pressed, pressed further beyond the key release start position Dr, and then released, and the position of the key 2a becomes equal to or higher than the key release start position Dr, it is determined that the release of the key 2a is started. The sound generation start position Ds is a position established below the key release start position Dr. When the key 2a is pressed and the position of the key 2a becomes equal to or low than the sound generation start position Ds, the generation of the normal musical sound is started.

Referring to FIG. 5A, the case where only the normal musical sound is generated is described. In the case where the key press of the key 2a is started and the position of the key 2a becomes equal to or lower than the sound generation start position Ds, the sound generation of the normal musical sound is started. At this time, the pitch corresponding to the pressed key 2a is set as the pitch of the normal musical sound. Subsequently, in the case where the key 2a is released at a position above the AT detection position Da, the normal musical sound continues to be generated even when the position of the key 2a reaches the key release start position Dr. Then, in the case where the position of the key 2a becomes equal to or higher than the sound silencing position D2, the normal musical sound is silenced.

Next, referring to FIG. 5B, the case where a special musical sound is generated after the sound generation of the normal musical sound, that is, the case where key release AT processing is performed, will be described. In the case where the key-pressing of the key 2a is started and the position of the key 2a becomes equal to or lower than the sound generation start position Ds, the generation of the normal musical sound of the key 2a is started, similar to the case in FIG. 5A. Subsequently, in the case where the key 2a is further pressed and the position of the key 2a becomes equal to or lower than the AT detection position Da, and then the key 2a is released and the position of the key 2a becomes equal to or higher than the key release start position Dr, the key release AT process is performed to switch the normal musical sound that is being generated to the special musical sound. At this time, the pitch corresponding to the pressed key 2a may be set as the pitch of the special musical sound.

More specifically, the time when the position of the pressed key 2a reaches the sound generation start position Ds is set as a sound generation start time Tss, the time when the position of the pressed key 2a reaches the AT detection position Da is set as a press start time Tas, the time when the position of the released key 2a returns and reaches the AT detection position Da again is set as a press end time Tae, and the time when the position of the further released key 2a returns and reaches the key release start position Dr is set as a key release start time Trs.

The special musical sound is generated in the case where the set times satisfy predetermined conditions. Specifically, the key release AT process for switching the normal musical sound being generated to a special musical sound is performed in the case where a time difference ΔT1 between the press start time Tas and the sound generation start time Tss is equal to or greater than a first time difference Ta, and a time difference ΔT2 between a press end time Tae and the press start time Tas is equal to or greater than a second time difference Tb, and a time difference ΔT3 between a key release start time Trs and the press start time Tas is equal to or less than a third time difference Tc. Then, in the case where the position of the key 2a becomes equal to or higher than the sound silencing position D2, the special musical sound that started to be generated by the key release AT process is silenced.

In the present embodiment, “50 milliseconds” is set as the first time difference, “300 milliseconds” is set as the second time difference, and “500 milliseconds” is set as the third time difference. However, the first time difference, the second time difference, and the third time difference are not limited to being set to the above times. For example, times other than those mentioned above may be set for the first time difference, the second time difference, and the third time difference according to the sound generation start position Ds or the AT detection position Da of the key 2a, or the level of performance technique of the user H.

In this way, with the position of the pressed key 2a reaching the sound generation start position Ds, the normal musical sound is generated, and in the case where the key 2a is further pressed to reach the AT detection position Da, at the time of key release of the key 2a, the key release AT process for switching the normal musical sound being generated to the special musical sound is performed. As a result, the user H can cause the key release AT process to be performed through a simple operation, which is to press the key 2a beyond the sound generation start position Ds where the normal musical sound is generated, so the operability for the user H when causing the key release AT process to be performed can be improved.

As a condition for causing such key release AT process to be performed, the time difference ΔT1 between the press start time Tas and the sound generation start time Tss is set to be equal to or greater than the first time difference Ta, and the time difference ΔT2 between the press end time Tae and the press start time Tas is set to be equal to or greater than the second time difference Tb, and the time difference ΔT3 between the key release start time Trs and the press start time Tas is set to be equal to or less than the third time difference Tc.

In other words, after the key 2a is pressed to the sound generation start position Ds, if the first time difference Ta does not elapse until the position of the key 2a is further pressed to the AT detection position Da, the key release AT process is not performed. Additionally, after the key 2a is pressed to the AT detection position Da, if that state is not maintained for the second time difference Tb or greater, the key release AT process is not performed. Therefore, it is possible to suppress a situation where the key release AT process is performed in the case where the user H unintentionally presses the key 2a vigorously (quickly) and the position of the key 2a temporarily (momentarily) becomes equal to or lower than the AT detection position Da.

Additionally, the user H needs bring the position of the key 2a to or lower than the AT detection position Da within the third time difference Tc before the released key 2a reaches the key release start position Dr, otherwise the key release AT processing may not be performed. Therefore, an unintended key release AT process by the user H can be suppressed. The conditions of the first time difference Ta, the second time difference Tb, and the third time difference Tc can improve the operability for the user H when causing the key release AT process to be performed.

Next, referring to FIG. 6, the function of the synthesizer 1 will be described. FIG. 6 is a functional block diagram of the synthesizer 1. As shown in FIG. 6, the synthesizer 1 includes a normal musical sound generation device 500 and a key release processing device 501.

The normal musical sound generation device 500 is a means for generating a normal musical sound in the case where the position of the key 2a reaches the sound generation start position Ds after the key 2a is pressed, and is realized by the CPU 100 to be described later with reference to FIG. 7. The key release processing device 501 is a means for performing the key release AT process at the time of key release of the key 2a, in the case where the position of the key 2a reaches the AT detection position Da, which is a deeper position than the sound generation start position Ds, by further pressing the key 2a after the position of the key 2a has reached the sound generation start position Ds, and is realized by the CPU 100.

That is, the user H can easily cause the key release AT process to be performed at the time of key release of the key 2a by performing an easy operation of pressing the key 2a to the AT detection position Da, which is deeper than the sound generation start position Ds where the normal musical sound is generated. Accordingly, the operability for the user H when causing the key release AT process to be performed can be improved.

Next, referring to FIG. 7, the electrical configuration of the synthesizer 1 will be described. FIG. 7 is a block diagram showing an electrical configuration of the synthesizer 1. The synthesizer 1 includes a CPU 100, a flash ROM 101, a RAM 102, the keyboard 2 and setting buttons P, a sound source 103, and a DSP (Digital Signal Processor) 104, which are connected to each other via a bus line 105. A digital analog converter (DAC) 106 is connected to the DSP 104, an amplifier 107 is connected to the DAC 106, and a speaker 108 is connected to the amplifier 107.

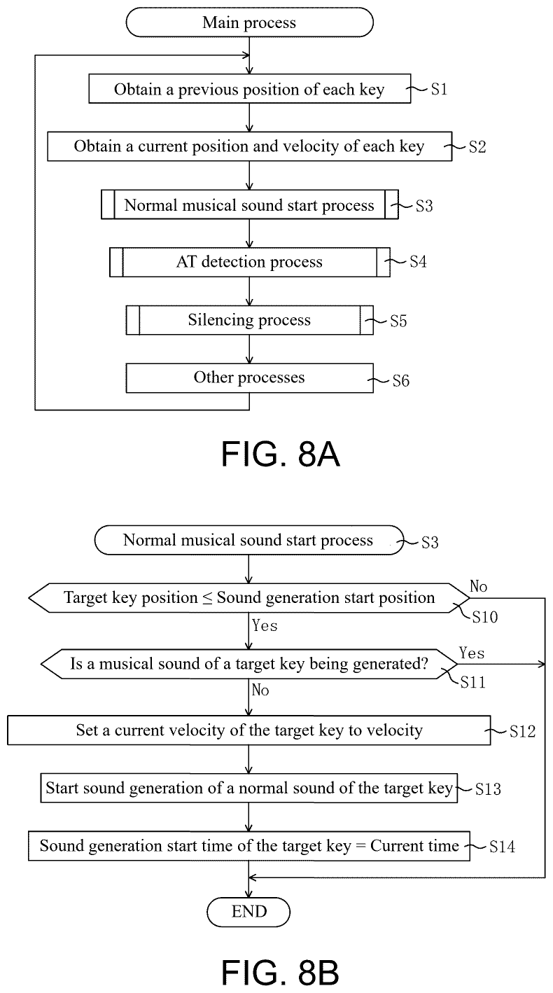

The CPU 100 is a computing device that controls each part connected via the bus line 105. The flash ROM 101 is a rewritable non-volatile memory and includes a control program 101a. When the control program 101a is executed by the CPU 100, a main process shown in FIG. 8A is executed. The RAM 12 is a memory that rewritably stores various work data, flags, etc., when the CPU 100 executes a program such as the control program 101a.

The sound source 103 is a device that outputs waveform data corresponding to the performance information input from the CPU 100. The DSP 104 is a computing device for performing a computational process on the waveform data input from the sound source 103. The DAC 106 is a conversion device that converts the waveform data input from the DSP 104 into analog waveform data. The amplifier 107 is an amplification device that amplifies the analog waveform data output from the DAC 106 at a predetermined gain. The speaker 108 is an output device that releases (outputs) the analog waveform data amplified by the amplifier 107 as a musical sound.

Next, referring to FIG. 8A to FIG. 10, the process executed by the CPU 100 will be described. FIG. 8A is a flowchart of the main process. The main process is executed when the power of the synthesizer 1 is turned on. The main process firstly obtains the previous position of each key 2a provided on the keyboard 2 (S1). Specifically, since the main process is executed repeatedly, the position of each key 2a obtained in the process of S2 (to be described afterwards) executed previously is obtained. After the process of S1, the current position and velocity of each key 2a are obtained (S2).

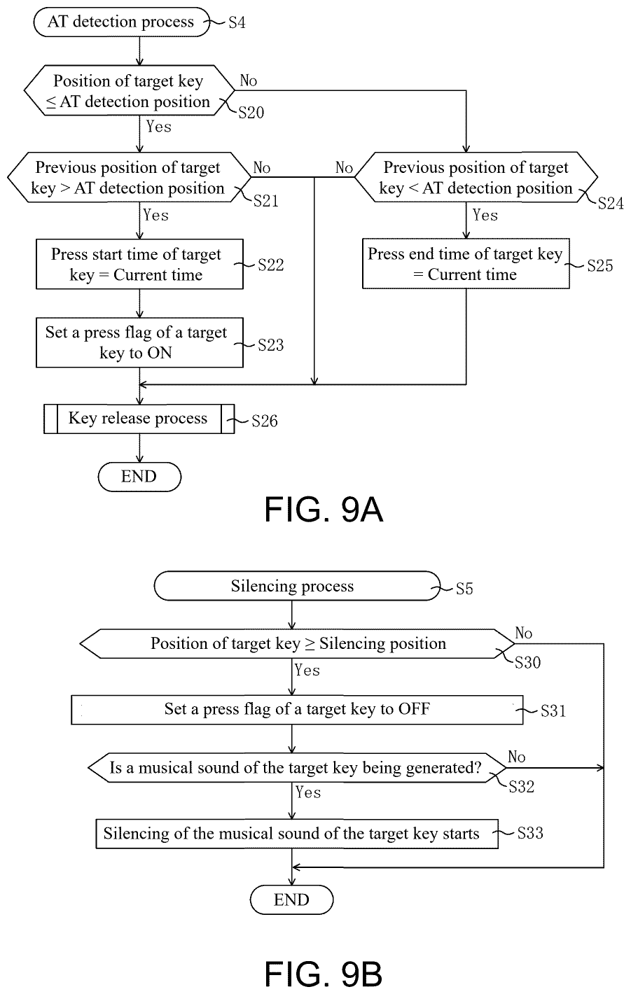

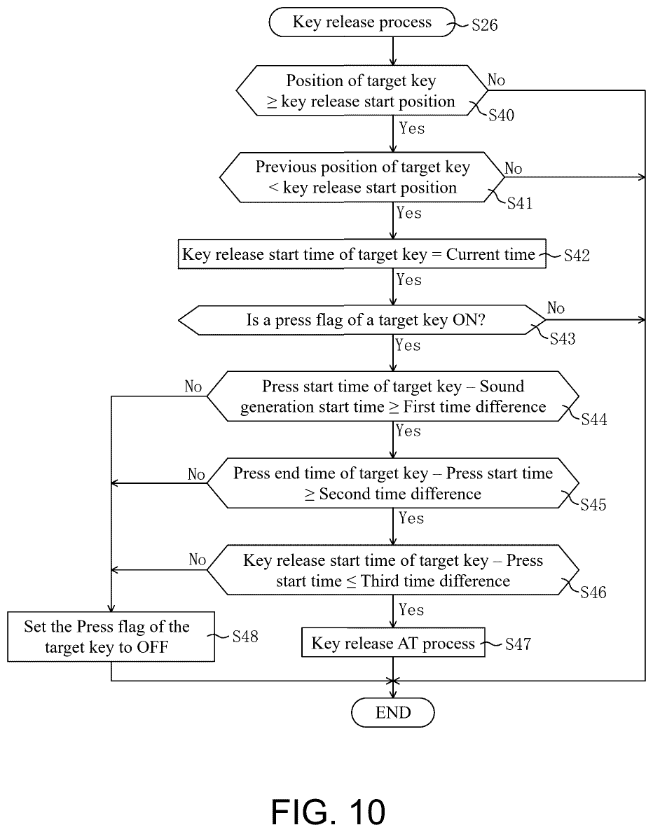

After the process of S2, the normal musical sound start process (S3), the AT detection process (S4), and the silencing process (S5) are executed in order. The processes S3 to S5 are executed for each key 2a. After the silencing process of S5, other processes of the synthesizer 1 (S6) are executed, and the processes from S1 onwards are repeated. Here, referring to FIG. 8B, FIGS. 9A and 9B, and FIG. 10, the normal musical sound start process of S3, the AT detection process of S4, and the silencing process of S5 will be described.

FIG. 8B is a flowchart of the normal musical sound start process. The normal musical sound start process is a process for starting the sound generation of the normal musical sound. The normal musical sound start process firstly confirms whether the position of the key 2a that is the target of the normal musical sound start process is equal to or lower than the sound generation start position Ds (S10). Hereinafter, the key 2a that is the target of the normal musical sound start process will be abbreviated as the “target key 2a”. The same applies to the AT detection process, the silencing process, and the key release process in FIGS. 9A and 9B and FIG. 10.

In the process of S10, in the case where the position of the target key 2a is equal to or lower than the sound generation start position Ds (S10: Yes), whether the musical sound of the target key 2a is being generated is confirmed (S11). Specifically, whether either the normal musical sound or the special musical sound of the target key 2a is being generated is confirmed.

In the process of S11, in the case where it is confirmed that the musical sound of the target key 2a is not being generated (S11: No), the current velocity of the target key 2a is set to a velocity Vs (S12), and the sound generation of the normal musical sound of the target key 2a is started (S13). After the process of S13, the current time is set to the sound generation start time Tss of the target key 2a (S14). In the embodiment, the current time is obtained from a real time clock (RTC, not shown) built in the synthesizer 1, but the current time may also be obtained in a different way, such as obtaining the current time from an NTP server. In the embodiment, the sound generation start time Tss, the press start time Tas, the press end time Tae, and the key release start time Trs described above in FIGS. 5A and 5B are set independently for each key 2a.

Meanwhile, in the process of S11, in the case where it is confirmed that the musical sound of the target key 2a is being generated (S11: Yes), the processes of S12 to S14 are skipped, and the generation of the normal musical sound of the target key 2a is not started.

That is, in the case where the position of the key 2a further reaches the sound generation start position Ds in the state where the normal musical sound or the special musical sound of the target key 2a is already being generated, the generation of the normal musical sound of the target key 2a is not performed. Since the situation where two different musical sounds are generated during a series of key pressing to key releasing can be suppressed, the sense of discomfort of the user H with respect to the generated musical sound can be suppressed.

In the process of S10, in the case where it is confirmed that the position of the target key 2a is higher than the sound generation start position Ds (S10: No), the processes of S11 to S14 are skipped. After the processes of S10, S11, and S14, the normal musical sound start process is ended.

FIG. 9A is a flowchart of the AT detection process. The AT detection process is a process for detecting whether the position of the target key 2a has reached the AT detection position Da. The AT detection process firstly confirms whether the position of the target key 2a is equal to or lower than the AT detection position Da (S20). In the process of S20, in the case where it is confirmed that the position of the target key 2a is equal to or lower than the AT detection position Da (S20: Yes), whether the previous position of the target key 2a is higher than the AT detection position Da is confirmed (S21).

In the process of S21, in the case where it is confirmed that the previous position of the target key 2a is higher than the AT detection position Da (S21: Yes), the current time is set to the press start time Tas of the target key 2a (S22). After the process of S22, a press flag of the target key 2a is set to ON (S23). The press flag is a flag indicating that the position of the target key 2a has reached the AT detection position Da, and is set independently for each target key 2a.

In the process of S21, in the case where it is confirmed that the previous position of the target key 2a is equal to or lower than the AT detection position Da (S21: No), the processes of S22 and S23 are skipped.

In the process of S20, in the case where it is confirmed that the position of the target key 2a is higher than the AT detection position Da (S20: No), whether the previous position of the target key 2a is lower than the AT detection position Da is confirmed (S24). In the process of S24, in the case where it is confirmed that the previous position of the target key 2a is lower than the AT detection position Da (S24: Yes), as this is the timing when the released target key 2a becomes equal to or higher than the AT detection position Da, the current time is set to the press end time Tae of the target key 2a (S25).

Meanwhile, in the process of S24, in the case where it is confirmed that the previous position of the target key 2a is equal to or higher than the AT detection position Da (S24: No), the process of S25 is skipped. After the processes of S21, S23, and S25, the key release process (S26) is executed, and the AT detection process is ended. Here, referring to FIG. 10, the key release process will be described.

FIG. 10 is a flowchart of a key release process. The key release process is a process for switching the normal musical sound being generated to the special musical sound based on the aftertouch operation of the target key 2a, that is, a process for performing the key release AT process. The key release process firstly confirms whether the position of the target key 2a is equal to or higher than the key release start position Dr (S40). In the process of S40, in the case where it is confirmed that the position of the target key 2a is equal to or higher than the key release start position Dr (S40: Yes), whether the previous position of the target key 2a is lower than the key release start position Dr (S41) is confirmed (S41).

In the process of S41, in the case where it is confirmed that the previous position of the target key 2a is lower than the key release start position Dr (S41: Yes), the current time is set to the key release start time Trs of the target key 2a (S42). After the process of S42, whether the press flag of the target key 2a is ON is confirmed (S43).

In the process of S43, in the case where it is confirmed that the press flag of the target key 2a is ON (S43: Yes), whether the time difference ΔT1 between the press start time Tas and the sound generation start time Tss of the target key 2a is equal to or more than the first time difference Ta is confirmed (S44). In the process of S44, in the case where it is confirmed that the time difference ΔT1 is equal to or higher than the first time difference Ta (S44: Yes), whether the time difference ΔT2 between the press end time Tae and the press start time Tas is equal to or more than the second time difference Tb is confirmed (S45). In the process of S45, in the case where it is confirmed that the time difference ΔT2 is equal to or more than the second time difference Tb (S45: Yes), whether the time difference ΔT3 between the key release start time Trs and the press start time Tas is equal to or lower than the third time difference Tc is confirmed (S46).

In the process of S46, in the case where it is confirmed that the time difference ΔT3 is equal to or lower than the third time difference Tc (S46: Yes), the key release AT process, that is, the process for switching the normal musical sound being generated to the special musical sound is performed (S47). Specifically, in the case where the normal musical sound of the target key 2a is being generated, the special musical sound is generated after the sound generation of the normal musical sound is ended. In the embodiment, for the velocity of the special musical sound when the sound generation starts, the velocity of the normal musical sound immediately before the sound generation is ended is used. However, the invention is not limited thereto. For example, the velocity set when the normal musical sound is generated in the process of S12 in FIG. 8B may be used, or a fixed value may be used.

In the process of S44, in the case where it is confirmed that the time difference ΔT1 is smaller than the first time difference Ta (S44: No), in the process of S45, in the case where it is confirmed that the time difference ΔT2 is smaller than the second time difference Tb (S45: No), or in the process of S46, in the case where it is confirmed that the time difference ΔT3 is greater than the third time difference Tc (S46: Yes), the press flag of the target key 2a is set to OFF (S48).

In the process of S40, in the case where it is confirmed that the position of the target key 2a is lower than the key release start position Dr (S40: No), the processes from S41 to S48 are skipped, and in the process of S41, in the case where it is confirmed that the previous position of the target key 2a is equal to or higher than the key release start position Dr (S41: No), the processes from S42 to S48 are skipped, and in the process of S43, in the case where it is confirmed that the press flag of the target key 2a is OFF (S43: No), the processes from S44 to S48 are skipped. After the processes of S40, S41, S43, S47, and S48, the key release process is ended.

Referring to FIG. 9B, FIG. 9B is a flowchart of the silencing process. The silencing process is a process for silencing the musical sound of the target key 2a that is being generated in the case where the position of the target key 2a becomes equal to or higher than the sound silencing position D2. The silencing process firstly confirms whether the position of the target key 2a is equal to or more than the sound silencing position D2 (S30). In the process of S30, in the case where it is confirmed that the position of the target key 2a is equal to or higher than the sound silencing position D2 (S30: Yes), the press flag of the target key 2a is set to OFF (S31).

After the process of S31, whether the musical sound of the target key 2a (i.e., the normal musical sound or the special musical sound of the target key 2a) is being generated is confirmed (S32). In the process of S32, in the case where it is confirmed that the musical sound of the target key 2a is being generated (S32: Yes), the silencing of the musical sound of the target key 2a is started (S33). On the other hand, in the process of S32, in the case where it is confirmed that the musical sound of the target key 2a is not being generated (S32: No), the process of S33 is skipped. Also, in the process of S30, in the case where it is confirmed that the position of the target key 2a is lower than the sound silencing position D2 (S30: No), the processes from S31 to S33 are skipped. After the processes of S30, S32, and S33, the silencing process is terminated.

While the description is made based on the above embodiment, it can be easily inferred that various improvements and modifications are possible.

In the embodiment, the key release AT process is performed for switching the normal musical sound being generated to the special musical sound at the time of key release of the key 2a in the case where the position of the key 2a becomes equal to or lower than the AT detection position Da, the time difference ΔT1 between the press start time Tas and the sound generation start time Tss is equal to or more than the first time difference Ta (hereinafter referred to as “the condition of the first time difference Ta”), the time difference ΔT2 between the press end time Tae and the press start time Tas is equal to or more than the second time difference Tb (hereinafter referred to as “the condition of the second time difference Tb”), and the time difference ΔT3 between the key release start time Trs and the press start time Tas is equal to or lower than the third time difference Tc (hereinafter referred to as “the condition of the third time difference Tc”). However, the disclosure is not limited to this.

For example, in the case where the position of the key 2a becomes equal to or lower than the AT detection position Da, it may also be that the key release AT process is performed at the time of key release of the key 2a regardless of the condition of the first time difference Ta, the condition of the second time difference Tb, and the condition of the third time difference Tc condition. Additionally, the key release AT process may also be performed in the case where the position of the key 2a is equal to or lower than the AT detection position Da and only the condition of the first time difference Ta is satisfied, or similarly, the key release AT process may be performed in the case where the position of the key 2a is equal to or lower than the AT detection position Da and only the condition of the second time difference Tb is satisfied, or the key release AT process may be performed in the case where the position of the key 2a is equal to or lower than the AT detection position Da and only the condition of the third time difference Tc is satisfied.

Alternatively, the key release AT process may also be performed in the case where the position of the key 2a is equal to or lower than the AT detection position Da and the conditions of the first time difference Ta and the second time difference Tb are satisfied, or the key release AT process may be performed in the case where the position of the key 2a is equal to or lower than the AT detection position Da and the conditions of the first time difference Ta and the third time difference Tc are satisfied, or the key release AT process may be performed in the case where the position of the key 2a is equal to or lower than the AT detection position Da and the conditions of the second time difference Tb and the third time difference Tc are satisfied.

Furthermore, conditions other than the condition of the first time difference Ta, the condition of the second time difference Tb, and the condition of the third time difference Tc (e.g., conditions of the velocity or acceleration of the key 2a when the key 2a reaches the AT detection position Da) may be added as conditions for performing the key release AT process.

In the embodiment, as the key release AT process, the process of switching the normal musical sound being generated to the special musical sound is performed at the time of key release of the key 2a. However, the key release AT process is not limited to this. As the key release AT process, a process of modifying the properties of the normal musical sound being generated may be performed at the time of key release of the key 2a.

For example, as the key release AT process, a process of changing the pitch of the normal musical sound being generated may be performed at the time of key release of the key 2a. At this time, the pitch of the normal musical sound may be varied according to the position of the key 2a at the time of aftertouch. For instance, the pitch of the normal musical sound may be lowered as the lower limit position of the key 2a at the time of aftertouch becomes smaller, and the pitch of the special musical sound may be raised as the lower limit position of the key 2a at the time of aftertouch becomes greater.

Additionally, at the time of key release of the key 2a, the pitch of the normal musical sound being generated may be continuously changed in a higher direction or a lower direction. The continuous change of the pitch at this time may be determined in advance or calculated each time. By continuously changing the pitch of the normal musical sound in this way, the sense of discomfort of the user H with respect to the change of the pitch of the normal musical sound can be suppressed. Alternatively, at the time of key release of the key 2a, the pitch of the normal musical sound being generated may be randomly changed.

Alternatively, as the key release AT process, a process of changing the timbre parameter of the normal musical sound being generated (parameters of setting items representing aspects of the timbre such as attack, decay, sustain or release, and cutoff frequency) may be performed at the time of key release of the key 2a. For example, at the time of key release of the key 2a, the release of the normal musical sound may be changed to be faster. Also, similar to the case of changing the pitch of the normal musical sound being generated as described above, the timbre parameter of the normal musical sound may be changed according to the position of the key 2a at the time of aftertouch, or the timbre parameter of the normal musical sound may be changed continuously or randomly.

Furthermore, as the key release AT process, a process of changing the degree of the acoustic effect (delay, reverb, etc.) applied to the normal musical sound being generated may be performed at the time of key release of the key 2a. For example, at the time of key release of the key 2a, the reverb applied to the normal musical sound may be changed to be stronger. Alternatively, similar to the case of changing the pitch of the normal musical sound being generated as described above, the degree of the acoustic effect applied to the normal musical sound may be varied according to the position of the key 2a at the time of aftertouch, or the degree of acoustic effect applied to the normal musical sound may be changed continuously or randomly.

In the above embodiment, in the case where the position of the target key 2a becomes equal to or lower than the AT detection position Da, the key release AT process related to the target key 2a and provided for switching the normal musical sound of the target key 2a to the special musical sound of the target key 2a is performed at the time of key release of the target key 2a,. However, the disclosure is not limited to this. For example, in the case where the position of the target key 2a becomes equal to or lower than the AT detection position Da, and another key 2a different from the target key 2a is being pressed at the time point, the key release AT process related to the other key 2a may be performed at the time of key release of the other key 2a.

As a result, by making only the position of the target key 2a equal to or lower than the AT detection position Da, not only the key release AT process related to the target key 2a but also the key release AT process related to the other key 2a being pressed simultaneously (or having been pressed) is performed. Therefore, the operability for the user H when performing the key release AT process related to multiple keys 2a can be improved.

In this case, all the keys 2a being pressed at the time when the position of the target key 2a becomes equal to or lower than the AT detection position Da may be considered as the “other keys 2a”, or any one of the keys 2a being pressed (for example, the key 2a closest to the target key 2a among the keys 2a being pressed) may be considered as the “other key 2a”.

In the above embodiment, a configuration is described where two types of musical sounds, a normal musical sound and a special musical sound, are generated for one key 2a. However, the disclosure is not limited to this, and a configuration may be adopted where three or more types of musical sounds (i.e., a normal musical sound and two or more types of special musical sounds) may be generated for one key 2a.

For example, the special musical sound to be generated may be switched according to the lower limit position of the pressed key 2a. In this case, two positions (a first position and a second position from the top) lower than the AT detection position Da are further provided. In the case where the lower limit of the key 2a when pressed is between the AT detection position Da and the first position, the sound may be switched to a first special musical sound at the subsequent time of key release. In the case where the lower limit of the key 2a when pressed is between the first position and the second position, the sound may be switched to a second special musical sound at the subsequent time of key release. In the case where the lower limit of the key 2a when pressed is lower than the second position, the sound may be switched to a third special musical sound at the subsequent time of key release. At this time, the multiple special musical sounds are not limited to different timbres. For example, as described above, the timbre of all the special musical sounds may be the same as the timbre of the normal musical sound, and the lower the lower limit position of the key 2a is pressed, the lower the pitch of the musical sound with that timbre may be used as the special musical sound generated at the time of key release.

Additionally, for example, the special musical sound to be generated may be switched according to the press time into the aftertouch performance region, that is, the length of the time difference ΔT2 between the press end time Tae and the press start time Tas. In this case, if the time difference ΔT2 is within 300 milliseconds to 350 milliseconds, the sound may be switched to the first special musical sound at the subsequent time of key release. If the time difference ΔT2 is within 350 milliseconds to 400 milliseconds, the sound may be switched to the second special musical sound at the subsequent time of key release. If the time difference ΔT2 is greater than 400 milliseconds, the sound may be switched to the third special musical sound at the subsequent time of key release.

In the above embodiment, the key release start position Dr is set above the sound generation start position Ds. However, the disclosure is not limited to this, and for example, the key release start position Dr and the sound generation start position Ds may be set at the same position. This allows the user H to easily make the time difference ΔT3 between the key release start time Trs and the press start time Tas shorter, thus making it easier to generate the special musical sound at the time of key release of the key 2a.

In the above embodiment, the control program 101a is stored in the flash ROM 101 of the synthesizer 1 and configured to operate on the synthesizer 1. However, the disclosure is not necessarily limited to this, and the control program 101a may be configured to operate on other computers such as a personal computer, a mobile phone, a smartphone, or a tablet terminal. In this case, a keyboard device with a configuration similar to the keyboard 2 may be connected to the PC, the mobile phone, or other device.

What is claimed is:

1. An electronic instrument, comprising a keyboard having a plurality of keys, the electronic instrument comprising:
a normal musical sound generation device, configured to generate a normal musical sound in a case where a position of the key reaches a sound generation start position after the key is pressed; and
a key release processing device, configured to perform a key release aftertouch process, which is a predetermined musical sound control process at a time of key release of the key, in a case where the position of the key reaches an aftertouch detection position as a position deeper than the sound generation start position through further pressing the key after the position of the key reaches the sound generation start position.

2. The electronic instrument as claimed in claim 1, wherein
the key release processing device is configured to perform the key release aftertouch process at the time of key release of the key, in a case where a time difference between a time when the position of the key reaches the sound generation start position and a time when the position of the key reaches the aftertouch detection position is equal to or greater than a first time difference.

3. The electronic instrument as claimed in claim 1, wherein
the key release processing device is configured to perform the key release aftertouch process at the time of key release of the key, in a case where a state that the position of the key is equal to or lower than the aftertouch detection position continues for a second time or greater.

4. The electronic instrument as claimed in claim 1, wherein
the key release processing device is configured to perform the key release aftertouch process at the time of key release of the key, in a case where a time difference between a time when the position of the key reaches the aftertouch detection position and a time when releasing of the key is started is equal to or less than a third time difference.

5. The electronic instrument as claimed in claim 1, wherein,
in a case where one of the keys reaches the aftertouch detection position and an other key differing from the one of the keys is pressed, the key release processing device is configured to perform the key release aftertouch process at a time of key release of the other key.

6. The electronic instrument as claimed in claim 1, wherein
the key release processing device is configured to perform the key release aftertouch process that changes a pitch of the normal musical sound that is being generated.

7. The electronic instrument as claimed in claim 1, wherein
the key release processing device is configured to perform the key release aftertouch process that changes a timbre parameter of the normal musical sound that is being generated.

8. The electronic instrument as claimed in claim 1, wherein
the key release processing device is configured to perform the key release aftertouch process that generates a special musical sound differing from the normal musical sound.

9. The electronic instrument as claimed in claim 8, wherein
the electronic instrument is configured so that the normal musical sound and the special musical sound differ in timbre.

10. The electronic instrument as claimed in claim 8, wherein
the electronic instrument is configured so that the normal musical sound and the special musical sound differ in pitch.

11. The electronic instrument as claimed in claim 8, wherein
the electronic instrument is configured so that the normal musical sound and the special musical sound differ in a timbre parameter.

12. The electronic instrument as claimed in claim 7, wherein
the electronic instrument is configured so that the timbre parameter is a release representing a musical tone reverberation.

13. The electronic instrument as claimed in claim 11, wherein
the electronic instrument is configured so that the timbre parameter is a release representing a musical tone reverberation.

14. A musical sound output method, executed by an electronic instrument comprising a keyboard having a plurality of keys, the musical sound output method comprising:
a normal musical sound generation step of generating a normal musical sound in a case where a position of the key reaches a sound generation start position after the key is pressed; and
a key release processing step of performing a key release aftertouch process, which is a predetermined musical sound control process at a time of key release of the key, in a case where the position of the key reaches an aftertouch detection position as a position deeper than the sound generation start position through further pressing the key after the position of the key reaches the sound generation start position.

15. The musical sound output method as claimed in claim 14, wherein
the key release processing step performs the key release aftertouch process at the time of key release of the key, in a case where a time difference between a time when the position of the key reaches the sound generation start position and a time when the position of the key reaches the aftertouch detection position is equal to or greater than a first time difference.

16. The musical sound output method as claimed in claim 14, wherein
the key release processing step performs the key release aftertouch process at the time of key release of the key, in a case where a state that the position of the key is equal to or lower than the aftertouch detection position continues for a second time or greater.

17. The musical sound output method as claimed in claim 14, wherein
the key release processing step performs the key release aftertouch process at the time of key release of the key, in a case where a time difference between a time when the position of the key reaches the aftertouch detection position and a time when releasing of the key is started is equal to or less than a third time difference.

18. The musical sound output method as claimed in claim 14, wherein,
in a case where one of the keys reaches the aftertouch detection position and an other key differing from the one of the keys is pressed, the key release processing step performs the key release aftertouch process at a time of key release of the other key.

19. The musical sound output method as claimed in claim 14, wherein
the key release aftertouch process changes a pitch of the normal musical sound that is being generated.

20. A non-transitory computer readable medium, storing a musical sound output program, causing a computer comprising a keyboard having a plurality of keys to execute a musical sound output process, the musical sound output program causing the computer to execute:
a normal musical sound generation step of generating a normal musical sound in a case where a position of the key reaches a sound generation start position after the key is pressed; and
a key release processing step of performing a key release aftertouch process, which is a predetermined musical sound control process when the key is released, in a case where the position of the key reaches an aftertouch detection position as a position deeper than the sound generation start position through further pressing the key after the position of the key reaches the sound generation start position.
